(19) United States
(12) Patent Application Publication
(10) Pub. No.: US 2009/0303202 A1
(43) Pub. Date: Dec. 10, 2009

(54) Capacitive Touch Screen

(76) Inventors: CHEN-YU LIU, Jhongli City (TW); Ching-Yi Wang, Jhongli City (TW)

Correspondence Address: HDLS Patent & Trademark Services, P.O. BOX 220746, CHANTILLY, VA, 20153-0746, US

(21) Appl. No.: 12/179,596

(22) Filed: Jul. 25, 2008

(30) Foreign Application Priority Data
Jun. 4, 2008 (TW) 097209834

(51) Int. Cl. G06F 3/044

(52) U.S. Cl. 345/174

(57) ABSTRACT

A capacitive touch screen includes a liquid crystal layer, an upper transparent conductive layer, a lower transparent conductive layer, an upper transparent plate, a lower transparent plate, an upper polarizing plate, a lower polarizing plate, a touch control circuit unit and a first dielectric layer. The upper transparent conductive layer, the first dielectric layer, the touch control circuit unit, the upper transparent plate and the upper polarizing plate are disposed on the liquid crystal layer in the above-mentioned order from one side of the liquid crystal layer. The lower transparent conductive layer, the lower transparent plate and the lower polarizing plate are disposed under the liquid crystal layer in the above-mentioned order from another side of the liquid crystal layer.

### BACKGROUND

The present invention relates to touch screens, and in particular relates to a capacitive touch screen.

In recent years, there has been an increase in demand for electronic devices, such as personal digital assistants (PDAs), mobile phones, and information appliances. To facilitate the users' input, many electronic devices employ touch panels as inputting devices.

Referring to FIG. 1, a conventional touch screen is shown. The touch screen includes a liquid crystal panel 1a, a touch panel 5, and an adhesive layer 6 between the liquid crystal panel 1a and the touch panel 5.

The touch panel 5 includes a glass plate 51, a touch control circuit layer 52 under the bottom surface of the glass plate 51 and a transparent over coat 55 under the touch control circuit layer 52. The touch control circuit layer 52 can be made of indium-tin oxide (ITO). The transparent over coat 55 is dielectric, which is connected to the adhesive layer 6. The transparent over coat 55 is used for preventing the touch control circuit layer 52 from being damaged/scratched. The transparent over coat 55 can be made of silicon nitride or silicon dioxide.

The liquid crystal panel la includes a liquid crystal layer 10a, an upper glass plate 11a, a lower glass plate 12a, an upper transparent conductive layer 13a, a lower transparent conductive layer 14a, an upper polarizing plate 15a and a lower polarizing plate 16a. The upper transparent conductive layer 13a, the upper glass plate 11a and the upper polarizing plate 15a are deposed on the liquid crystal layer 10a in the above-mentioned order, and the upper polarizing plate 15a is connected to the adhesive layer 6. The lower transparent conductive layer 14a, the lower glass plate 12a and the lower polarizing plate 16a are positioned under the liquid crystal layer 10a in the above-mentioned order.

By a pen or a finger pressing at images or letter icons generated from the liquid crystal panel 1a on an outer surface of the touch screen, the user can input signals into the touch screen.

Generally, in a process of manufacturing the touch screen, the touch panel 5 and the liquid crystal panel 1a are made separately at first, and then the touch panel 5 and the liquid crystal panel la are assembled together. However, the process of assembling the touch panel 5 and the liquid crystal panel 1a requires high precision and costs time. In addition, the touch screen has a relatively high thickness.

What is needed, therefore, is a new touch screen that can overcome the above-mentioned shortcomings.

### BRIEF SUMMARY

A capacitive touch screen includes a liquid crystal layer, an upper transparent conductive layer, a lower transparent conductive layer, an upper transparent plate, a lower transparent plate, an upper polarizing plate, a lower polarizing plate, a touch control circuit unit and a first dielectric layer. The upper transparent conductive layer, the first dielectric layer, the touch control circuit unit, the upper transparent plate and the upper polarizing plate are disposed on the liquid crystal layer in the above-mentioned order from one side of the liquid crystal layer. The lower transparent conductive layer, the lower transparent plate and the lower polarizing plate are disposed under the liquid crystal layer in the above-mentioned order from another side of the liquid crystal layer.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, cross-sectional view of a conventional touch screen.

FIG. 2 is a schematic, cross-sectional view of a capacitive touch screen according to a first exemplary embodiment.

FIG. 3 is a schematic, top plan view of a touch control circuit unit of the capacitive touch screen of FIG. 2.

FIG. 4 is a schematic, cross-sectional view of a capacitive touch screen according to a second exemplary embodiment.

FIG. 5 is a schematic, cross-sectional view of a capacitive touch screen according to a third exemplary embodiment.

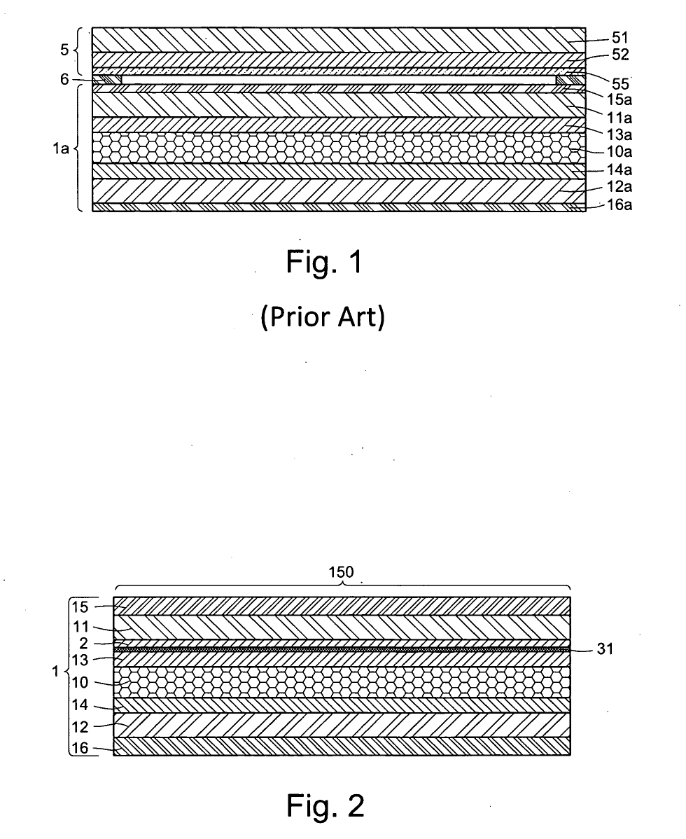

### DETAILED DESCRIPTION

Reference will now be made to the drawings to describe various exemplary embodiments of the present capacitive touch screen in detail.

Referring to FIG. 2, a capacitive touch screen 1 according to a first exemplary embodiment is shown. The capacitive touch screen 1 includes a liquid crystal layer 10, an upper transparent plate 11, a lower transparent plate 12, an upper transparent conductive layer 13, a lower transparent conductive layer 14, an upper polarizing plate 15, a lower polarizing plate 16, a touch control circuit unit 2 and a first dielectric layer 31. The upper transparent conductive layer 13, the first dielectric layer 31, the touch control circuit unit 2, the upper transparent plate 11 and the upper polarizing plate 15 are disposed on the liquid crystal layer 10 in the above-mentioned order from one side of the liquid crystal layer 10. A display region 150 is defined on the upper polarizing plate 15. The lower transparent conductive layer 14, the lower transparent plate 12 and the lower polarizing plate 16 are disposed under the liquid crystal layer 10 in the above-mentioned order from another side of the liquid crystal layer 10.

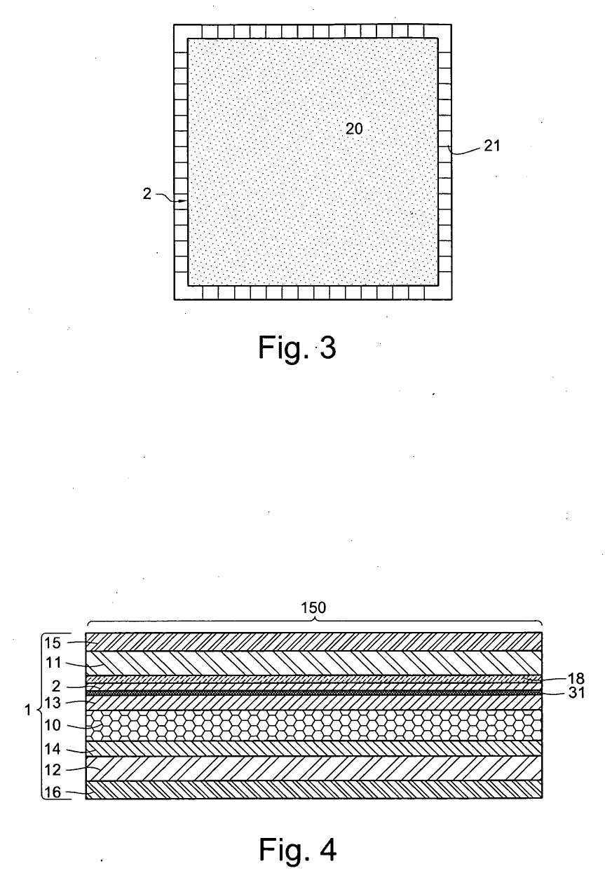

Referring to FIG. 3, the touch control circuit unit 2 includes a conductive film 20 and at least a conductive line 21 connected to a periphery of the conductive film 20. In this embodiment, there are a plurality of conductive lines 21 connected to the periphery of the conductive film 20. A driving voltage of a predetermined voltage level is provided on the conductive film 20, such that a uniform voltage is produced on the conductive film 20. In an alternative embodiment, the driving voltage of the predetermined voltage level is provided on one side of the conductive film 20, and the other side of the conductive film 20 is ground connection, such that a gradient voltage is produced on the conductive film 20.

Each of the upper transparent plate 11 and the lower transparent plate 12 can be made of a material selected from a group consisting of glass, plastic or other dielectric materials. The conductive film 20 of the touch control circuit unit 2 can be made of a transparent electric material, such as indium-tin oxide. The touch control circuit unit 2 can be formed by a method including: coating, exposing, developing and etching.

The images or letter icons can display on the display region 150. If a finger or other electric body presses at a position on the display region 150, the conductive film 20 corresponding to the position would be induced by the finger or other electric body to generate a capacitive effect, due to the conductive film 20 having the uniform voltage or the gradient voltage. In this way, induction signals, such as electric current changing signals, are generated, and the induction signals can be transmitted to an external processor (not shown) via the conductive lines 21. The external processor computes the induction signals to achieve a purpose of touch control.

Because the capacitive touch screen 1 includes the touch control circuit unit 2 under the upper transparent plate 11, a conventional touch panel can be omitted. Therefore a process of assembly of the capacitive touch screen 1 is simplified, and an efficiency of assembly is improved. Furthermore, some materials, such as a glass plate of the conventional touch panel, can be omitted, thus a thickness of the capacitive touch screen 1 is reduced, so as to meet the design trend of thinness of the electronic devices. In addition, because the glass plate of the conventional touch panel can be omitted and the efficiency of assembly is improved, the production cost of capacitive touch screen 1 is relatively low.

It should be pointed out that the upper transparent conductive layer 13 can be used as a shielding layer for rejecting noise. The conductive film 20 of the touch control circuit unit 2 can be made of an opaque metal, so as to replace a black matrix layer of a conventional screen for blocking light. The opaque metal can be chromium (Cr).

In addition, an added shielding layer can be configured between the touch control circuit unit 2 and the upper transparent conductive layer 13. The shielding layer is dielectric with the touch control circuit unit 2 and the upper transparent conductive layer 13. The shielding layer may reject noise, thereby isolating electromagnetism interference of driving the touch screen 1.

Referring to FIG. 4, a capacitive touch screen 1 according to a second exemplary embodiment is shown. The capacitive touch screen 1 of the second exemplary embodiment is similar in principle to the capacitive touch screen 1 of the first exemplary embodiment described above, and also includes a liquid crystal layer 10, an upper transparent plate 11, a lower transparent plate 12, an upper transparent conductive layer 13, a lower transparent conductive layer 14, an upper polarizing plate 15, a lower polarizing plate 16, a touch control circuit unit 2 and a first dielectric layer 31. However, the first dielectric layer 31 is used as a color resist layer, and the capacitive touch screen 1 of the second exemplary embodiment further includes an opaque blocking layer 18 located between the upper transparent plate 11 and the touch control circuit unit 2. The opaque blocking layer 18 can be a black matrix layer or other coating for blocking light. It is understood that the upper transparent conductive layer 13 can also be used as a shielding layer for rejecting noise in this embodiment.

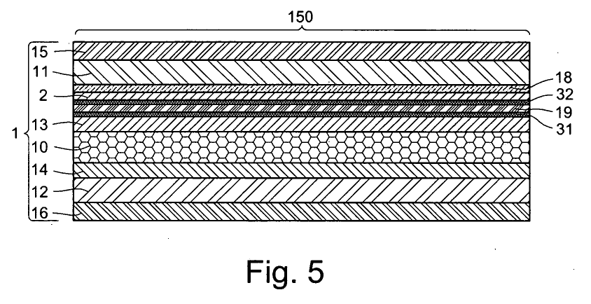

Referring to FIG. 5, a capacitive touch screen 1 according to a third exemplary embodiment is shown. The capacitive touch screen 1 of the third exemplary embodiment is similar in principle to the capacitive touch screen 1 of the first exemplary embodiment described above, and also includes a liquid crystal layer 10, an upper transparent plate 11, a lower transparent plate 12, an upper transparent conductive layer 13, a lower transparent conductive layer 14, an upper polarizing plate 15, a lower polarizing plate 16, a touch control circuit unit 2 and a first dielectric layer 31. However, the capacitive touch screen 1 of the third exemplary embodiment further includes a shielding layer 19 located between the upper transparent conductive layer 13 and the touch control circuit unit 2. The shielding layer 19 is located on a side of the first dielectric layer 31 far from the upper transparent conductive layer 13. The shielding layer 19 is dielectric with the touch control circuit unit 2 and the upper transparent conductive layer 13. The shielding layer 19 may reject noise, thereby isolating electromagnetism interference of driving the capacitive touch screen 1. In an alternative embodiment, the first dielectric layer 31 can be used as a color resist layer, and the capacitive touch screen 1 further includes an opaque blocking layer 18 and a second dielectric layer 32. The opaque blocking layer 18 is located between the upper transparent plate 11 and the touch control circuit unit 2. The second dielectric layer 32 is located between the touch control circuit unit 2 and the shielding layer 19. The opaque blocking layer 18 can be a black matrix layer or other coating for blocking light.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A capacitive touch screen comprising: a liquid crystal layer, an upper transparent conductive layer, a lower transparent conductive layer, an upper transparent plate, a lower transparent plate, an upper polarizing plate, a lower polarizing plate, a touch control circuit unit and a first dielectric layer; wherein the upper transparent conductive layer, the first dielectric layer, the touch control circuit unit, the upper transparent plate and the upper polarizing plate are sequentially disposed on the liquid crystal layer from one side of the liquid crystal layer; and the lower transparent conductive layer, the lower transparent plate and the lower polarizing plate are sequentially disposed under the liquid crystal layer from another side of the liquid crystal layer.

2. The capacitive touch screen according to claim 1, wherein the touch control circuit unit comprises a conductive film and at least a conductive line connected with a periphery of the conductive film.

3. The capacitive touch screen according to claim 1, wherein the capacitive touch screen further comprises a shielding layer located between the touch control circuit unit and the upper transparent conductive layer for rejecting noise, and the shielding layer is dielectric with the touch control circuit unit and the upper transparent conductive layer.

4. The capacitive touch screen according to claim 1, wherein the upper transparent conductive layer is used for rejecting noise.

5. The capacitive touch screen according to claim 4, wherein a conductive film of the touch control circuit is made of an opaque metal.

6. The capacitive touch screen according to claim 1, wherein the first dielectric layer is a color resist layer.

7. The capacitive touch screen according to claim 6, wherein the upper transparent conductive layer is used for rejecting noise.

8. The capacitive touch screen according to claim 6, wherein the capacitive touch screen further comprises a shielding layer and a second dielectric layer, the shielding layer located between the touch control circuit unit and the first dielectric layer for rejecting noise, and the second dielectric layer located between the touch control circuit unit and the shielding layer.
